(19) United States
(12) Patent Application Publication
(10) Pub. No.: US 2026/0280237 A1
(43) Pub. Date: Sep. 17, 2026

(54) RETROFIT MICROGRID INTERCONNECT DEVICE (MID) INTO SQUARE D COMMON SERVICE ENTRANCE DEVICE (CSED) PANELS STACKED WITH MAIN BREAKER

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 19/076,206

(22) Filed: Mar. 11, 2025

(51) Int. Cl. H02B 1/056; H02B 1/20

(52) U.S. Cl. CPC H02B 1/056; H02B 1/20

(57) ABSTRACT

A method of retrofitting an electrical panel includes removing a main breaker from an interior, wherein the interior is installed a panel housing of the electrical panel. The method includes removing a first line strap from connecting a first line bus of the interior to a first line of the electrical panel and removing a second line strap from connecting a second line bus of the interior to a second line of the electrical panel. A microgrid interconnect device (MID) is installed onto the interior in a position formerly occupied by the main breaker. The main breaker is connected in electrical series between the first and second lines of the electrical panel and the MID.

### BACKGROUND

### 1. Field

The present disclosure relates to electrical panels, and more particularly to microgrid interconnect devices (MID's) for connecting and disconnecting residential electrical panels such as common service entrance device (CSED) panels from utility grids.

### 2. Description of Related Art

It is common for CSED panels to need an MID, but there is no provision to add an MID to a CSED panel easily. One solution has been to locate an MID inside the meter collar, but that is location is not always compliant with utility regulations. Ideally, there would be enough room in the CSED panel itself to locate an MID physically in between the main breaker and the interior. However in legacy CSED configurations there is not enough room in the vertical direction to fit an MID physically. While there are some new install options for accommodating MID's in CSED panels, they do not solve the problem of retrofitting legacy CSED panels to include MID's. Existing retrofit solutions require relocating the branch breakers, which is not ideal.

The conventional techniques have been considered satisfactory for their intended purpose. However, there is an ever-present need for improved systems and methods for incorporating MID's with CSED panels, including methods for retrofitting legacy CSED panels to include MID's. This disclosure provides a solution for this need.

### SUMMARY

A method of retrofitting an electrical panel includes removing a main breaker from an interior, wherein the interior is installed a panel housing of the electrical panel. The method includes removing a first line strap from connecting a first line bus of the interior to a first line of the electrical panel and removing a second line strap from connecting a second line bus of the interior to a second line of the electrical panel. A microgrid interconnect device (MID) is installed onto the interior in a position formerly occupied by the main breaker. The main breaker is connected in electrical series between the first and second lines of the electrical panel and the MID.

Connecting the main breaker can include connecting a first replacement line strap to the first line of the electrical panel. The first replacement line strap can extend from a first level proximate a back interior surface of the panel housing to an elevated level spaced apart from the back interior surface and from the first level. Connecting the main breaker can include connecting a second replacement line strap to the second line of the electrical panel. The second replacement line strap can extend from the first level to the elevated level. Connecting the main breaker can include connecting the main breaker to the first line strap and to the second line strap at the elevated level. With the main breaker in an ON state, the main braker can connect the first line of the electrical panel in series with a first line connector of the MID and can connect the second line of the electrical panel in series with a second line connector of the MID. With the MID in an ON state, the MID can connect the first line connector of the MID to the first line bus of the interior and can connect the second line connector of the MID to the second line bus of the interior.

Prior to removing the main breaker, there can be a plurality of branch devices installed on the interior, electrically connecting the first and second line busses of the interior to individual branch circuits. The method can include keeping the plurality of branch devices installed before, during, and after removing the main breaker, installing the MID, and connecting the main breaker in series between the first and second lines of the electrical panel and the MID.

The method can include connecting an MID controller to the MID and mounting the MID controller in the electrical panel. The method can include connecting an external device a communication port of the MID controller.

Prior to removing the main breaker from the interior, the method can include removing a deadfront from the panel housing to provide access to the interior of the electrical panel. After installing the MID and connecting the main breaker in series between the first and second lines of the electrical panel and the MID, the method can include re-installing the deadfront or installing a new deadfront to the panel housing.

A microgrid interconnect device (MID) includes a switching device. A first line connector is electrically connected to the switching device and configured to connect to a first line of an electrical panel. A second line connector is electrically connected to the switching device and configured to connect to a second line of the electrical panel. A first load connector is electrically connected to the switching device and configured to connect to a first line bus of an interior of the electrical panel. A second load connector is electrically connected to the switching device and configured to connect to a second line bus of the interior. The switching device is configured to switch back and forth between an ON state and an OFF state. In the ON state, the switching device electrically connects the first line connector to the first load connector and electrically connects the second line connector to the second load connector. In the OFF state, the switching device electrically isolates the first line connector from the first load connector and electrically isolates the second line connector from the second load connector.

A housing can be included, wherein the switching device is in an interior space of the housing. Each of the first load connector, the second load connector, the first line connector, and the second line connector can extend from an exterior space, through the housing, and into the interior space of the housing. The housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction closer to the first elevation than is the second elevation. The housing can be configured to fit in an envelope of a QOM2 main breaker.

A printed circuit board assembly (PCBA) can be included within the interior space of the housing. The PCBA can include a controller configured to control the switching device to switch the switching device back and forth between the ON state and the OFF state. A first sensor can be operatively connected to feedback signals indicative of current in the first load connector to the controller for feedback based control of the switching device. A second sensor can be operatively connected to feedback signals indicative of current in the second load connector to the controller for feedback based control of the switching device. At least one communication port can be configured for connection to devices outside of the housing. The at least one communication port can be operatively connected to the PCBA for data exchange between the PCBA and an external device.

An electrical panel can include a panel housing defining a back interior surface and can include a first line and a second line. An interior can be included in the panel housing adjacent the back interior surface. A main breaker can be connected mechanically and electrically to the first line and to the second line. A microgrid interconnect device (MID) can be included in the panel housing. The MID can be connected mechanically to the interior and to the main breaker. The MID can be connected in electrical series between the main breaker and the interior.

A plurality of branch devices can be operatively connected to the interior to control individual circuits respectively connected to the branch devices by respective wires. The MID can include a switching device.

A first line connector can be electrically connected to the switching device and to the first line of the panel housing through the main breaker. A second line connector can be electrically connected to the switching device and to the second line of the panel housing through the main breaker. A first load connector can be electrically connected to the switching device and to a first line bus of the interior. A second load connector can be electrically connected to the switching device and to a second line bus of the interior. The switching device can be configured to switch back and forth between an ON state and an OFF state. In the ON state, the switching device can electrically connect the first line connector to the first load connector and can electrically connect the second line connector to the second load connector. In the OFF state, the switching device can electrically isolate the first line connector from the first load connector and can electrically isolate the second line connector from the second load connector.

An MID housing can be included. The switching device can be in an interior space of the MID housing. Each of the first load connector, the second load connector, the first line connector, and the second line connector can extend from an exterior space, through the MID housing, and into the interior space of the MID housing. A neutral line of the panel housing can connect directly to a neutral bus of the interior. The MID housing can include a back surface at a first elevation in a z-direction defined perpendicular to the back surface. Respective terminals of the first and second line connectors can be positioned at a second elevation in the z-direction spaced apart from the first elevation. Terminals of the first and second load connectors can be positioned at a third elevation in the z-direction closer to the first elevation than is the second elevation. A printed circuit board assembly (PCBA) can be included within the interior space of the MID housing. The PCBA can include a controller configured to control the switching device to switch the switching device back and forth between the ON state and the OFF state. A first sensor can be operatively connected to feedback signals indicative of current in the first load connector to the controller for feedback based control of the switching device. A second sensor can be operatively connected to feedback signals indicative of current in the second load connector to the controller for feedback based control of the switching device. At least one communication port can be included, configured for connection to devices outside of the MID housing. The at least one communication port can be operatively connected to the PCBA for data exchange between the PCBA and an external device.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of an electrical panel for retrofitting in accordance with the present disclosure, showing the panel housing and deadfront prior to retrofitting to include a microgrid interconnect device (MID);

FIG. 2 is a schematic perspective view of the electrical panel of FIG. 1, showing the deadfront removed from the panel housing;

FIG. 3 is a is a schematic perspective view of the electrical panel of FIG. 2, showing the main breaker and straps removed from the interior;

FIG. 4 is a is a schematic perspective view of the electrical panel of FIG. 3, showing the MID installed onto the interior;

FIG. 5 is a schematic perspective view of the MID of FIG. 4, showing the connectors of the MID;

FIG. 6 is a schematic cut away perspective view of the MID of FIG. 3, showing the components inside the MID housing;

FIG. 7 is a schematic perspective view of the electrical panel of FIG. 4, showing the main breaker connected to the MID and to the replacement straps;

FIG. 8 is a schematic perspective view of the electrical panel of FIG. 7, showing an MID controller installed onto the interior; and

FIG. 9 is a schematic perspective view of the electrical panel of FIG. 8, showing a deadfront mounted over the interior to enclose the interior inside the panel housing.

### DETAILED DESCRIPTION OF THE PREFERRED EMBODIMENTS

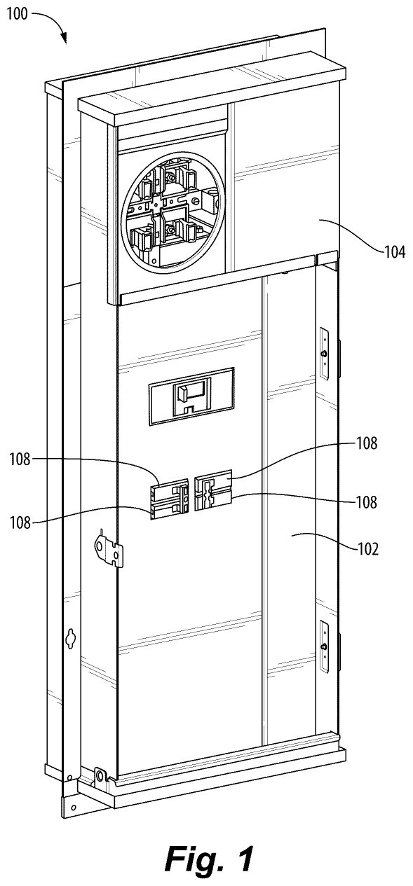

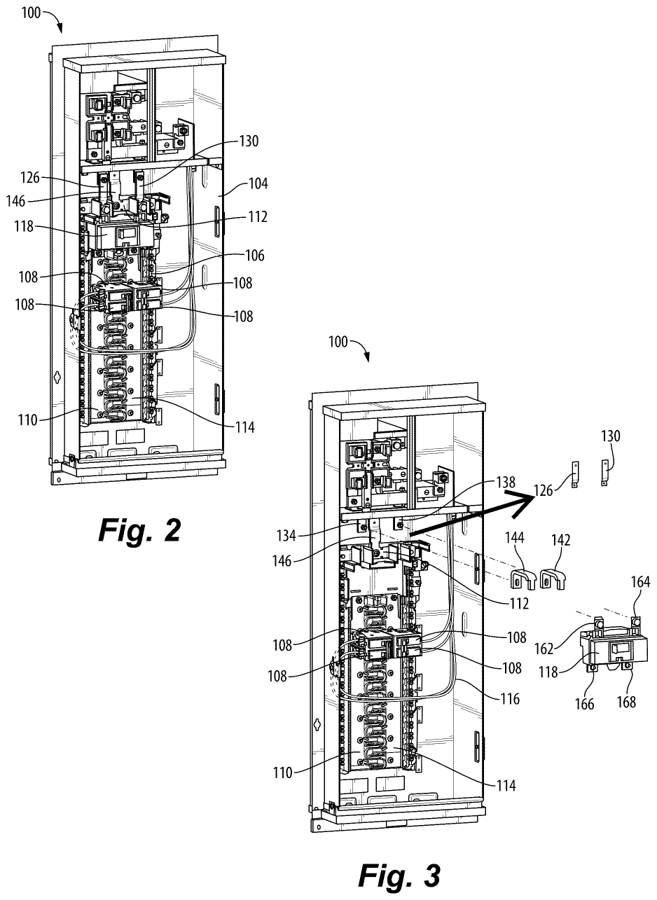

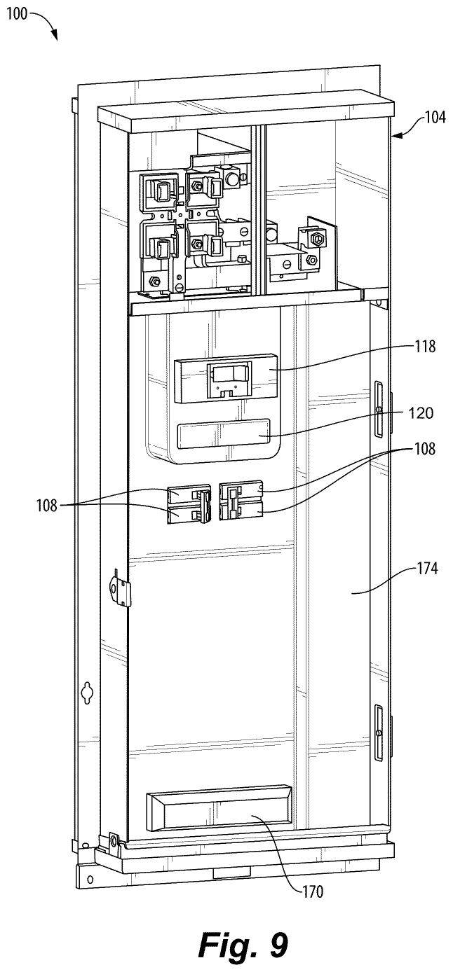

Reference will now be made to the drawings wherein like reference numerals identify similar structural features or aspects of the subject disclosure. For purposes of explanation and illustration, and not limitation, a partial view of an embodiment of an electrical panel for retrofitting in accordance with the disclosure is shown in FIG. 1 and is designated generally by reference character 100. Other embodiments of systems in accordance with the disclosure, or aspects thereof, are provided in FIGS. 2-9, as will be described. The systems and methods described herein can be used for new installations or to retrofit legacy electrical panels such as common service entrance device (CSED) panels, indoor/outdoor load centers, or the like, to include a microgrid interconnect device (MID).

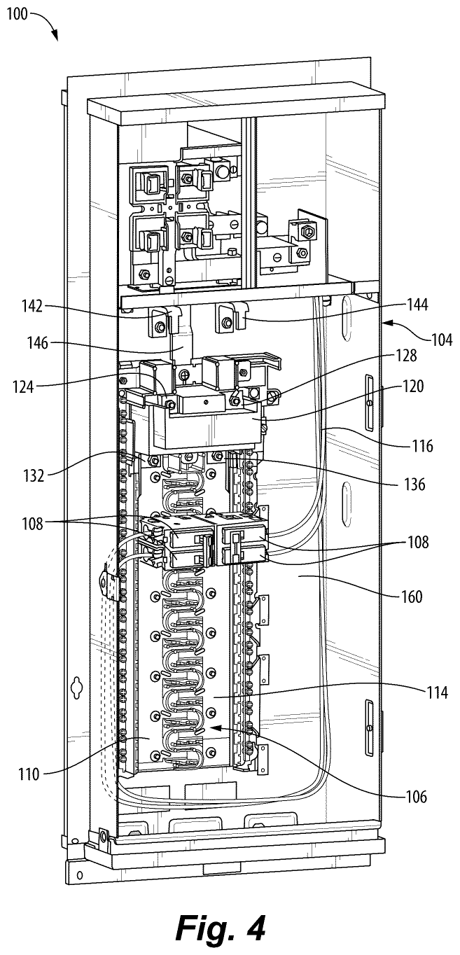

A method of retrofitting can start with an electrical panel 100 such as a Square D CSED panel, an indoor/outdoor load center, or the like, as shown in FIG. 1. Prior to the retrofit, the utility can turn off the meter, e.g., cutting the grid power off to the electrical panel 100. As shown in FIG. 2, the method includes removing a legacy deadfront 102 from the electrical panel housing 104 to provide access to an interior 106 that is installed in the panel housing 104, as shown in FIG. 2. A plurality of branch devices 108, e.g. circuit breakers, are installed on the interior, operatively connecting the busses 110, 112, 114 of the interior 106 to control individual branch circuits by wires 116 prior to the retrofit, and can remain installed with the interior 106 in the panel housing 104 throughout the retrofit until finished. A neutral line 146 of the panel housing 104 connects directly to the neutral bus 112 of the interior 106, and can remain connected before, during, and after a retrofit. The method includes removing the main circuit breaker 118, e.g. a QOM2 circuit breaker, from the interior 106 as shown in FIG. 3. As also shown in FIG. 3, the method includes removing first and second line straps 126, 130 from connecting first and second line busses 110, 114 of the interior to first and second lines 134, 138 of the electrical panel 100, respectively. Replacement line straps 142, 144 are installed into the panel housing 104, electrically connected to the first and second lines 134, 138, respectively, to replace the original straps 126, 130, as shown in FIG. 4. The removal of the main breaker 118 and the original straps 126, 130 is indicated in FIG. 3 with the large arrow out of the panel housing 104, and the installation of the replacement line straps 142, 144 is indicated by the broken lines extending into the panel housing 104.

With reference now to FIG. 4, the method includes installing a microgrid interconnect device (MID) 120 mechanically onto the interior 106 onto a position formerly occupied by the main breaker 118. This includes electrically and mechanically connecting respective busses 110, 114 of the interior 106 to the MID 120, wherein the neutral line 146 bypasses the MID 120 (and eventually the main breaker 118) and connects directly to the neutral bus 112 of the interior 106 as shown in FIG. 3.

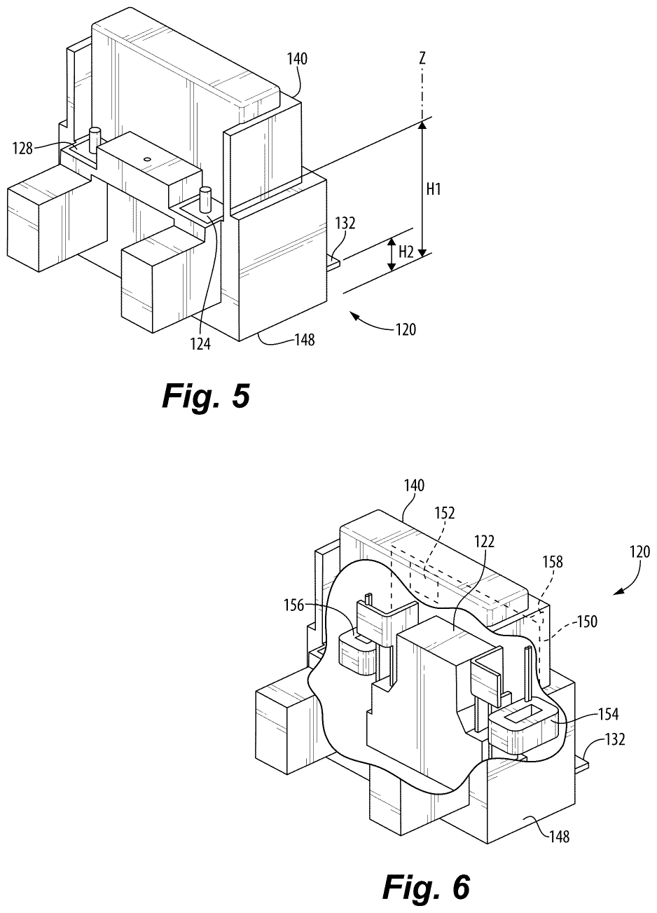

With reference now to FIGS. 5-6, the MID 120 includes a switching device 122, e.g. a 200A relay. A first line connector 124 is electrically connected to the switching device 122. A second line connector 128 is electrically connected to the switching device 122. A first load connector 132 is electrically connected to the switching device 122 and to a first line bus 110 of the interior 106. A second load connector 136 (labeled in FIG. 4) is electrically connected to the switching device 122 and to a second line bus 114 of the interior 106. The switching device 122 is configured to switch back and forth between an ON state and an OFF state. In the ON state, the switching device 122 electrically connects the first line connector 124 to the first load connector 132 and electrically connects the second line connector 128 to the second load connector 136 (labeled in FIG. 4). In the OFF state, the switching device 122 electrically isolates the first line connector 124 from the first load connector 132 and electrically isolates the second line connector 128 from the second load connector 136 (labeled in FIG. 4).

With continued reference to FIG. 6, the MID 120 includes an MID housing 140 that is configured to fit in an envelope of a QOM2 main breaker. The switching device 122 is in an interior space of the housing 140. Each of the first line connector 124, and the second line connector 128, the first load connector 132, the second load connector 136 (labeled in FIG. 4), extends from an exterior space, through a wall of the housing 140, and into the interior space of the housing 140.

With reference again to FIG. 5, the MID housing 140 includes a back surface 148 at a zero elevation in a z-direction defined perpendicular to the back surface. Respective terminals of the first and second line connectors 124, 128 are positioned at an elevation H1 in the z-direction spaced apart from the zero elevation of the back surface 148. Terminals of the first and second load connectors 132, 136 (labeled in FIG. 4) are positioned at an elevation H2 in the z-direction closer to the zero elevation of the back surface 148 than is the elevation H1. The neutral line 146, labeled in FIG. 4, extends underneath the back surface 148 when assembled to the interior 106 as shown in FIG. 4.

With reference again to FIG. 6, a printed circuit board assembly (PCBA) 150 is included within the interior space of the MID housing 140. The PCBA 150 includes a controller 152 configured to control the switching device 122 to switch the switching device 122 back and forth between the ON state and the OFF state. A first sensor 154 is operatively connected to feedback signals indicative of current in the first load connector 132 to the controller 152 for feedback based control of the switching device 122. A second sensor 156 is operatively connected to feedback signals indicative of current in the second load connector 136 (labeled in FIG. 4) to the controller 152 for feedback based control of the switching device 122. At least one communication port 158 can be included, configured for connection of the controller 152 to devices outside of the MID housing 140. The at least one communication port 158 is operatively connected to the PCBA 150 for data exchange between the PCBA 150 and an external device.

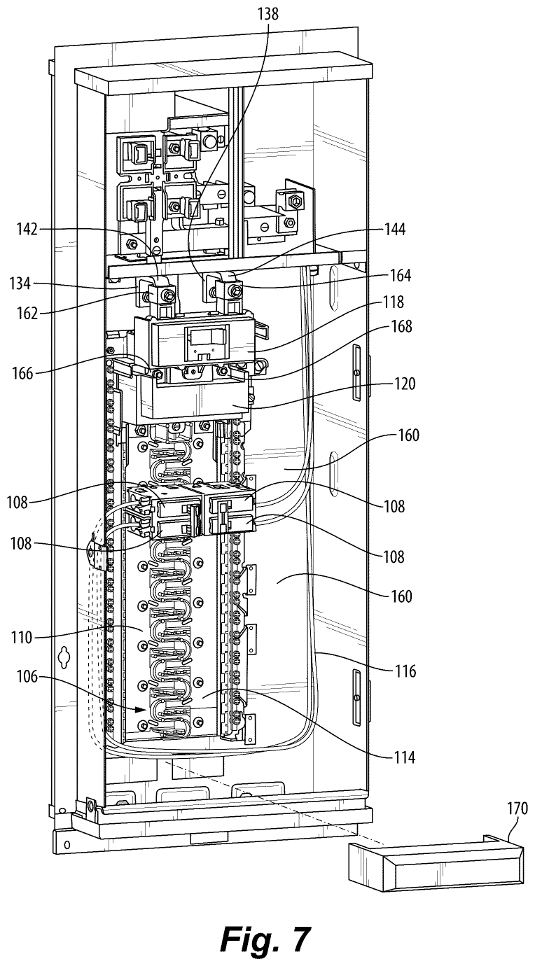

With reference now to FIG. 7, the main breaker 118 is connected mechanically and electrically in series between the first and second lines 134, 138 of the electrical panel 100 and to the MID 120, so the MID 120 is connected in electrical series between the main breaker 118 and the first and second line busses 110, 114 of the interior 106. Connecting the main breaker 118 includes connecting the first replacement line strap 142 to the first line 134 of the electrical panel 100, wherein the first replacement line strap 142 extends from a first level proximate a back interior surface 160 of the panel housing (to which the interior 106 is adjacent) to an elevated level spaced apart from the back interior surface 160 and from the first level. Similarly, a second replacement line strap 144 is connected to the second line 138 of the electrical panel 100, wherein the second replacement line strap 144 also extends from the first level to the elevated level. With the replacement line straps 142, 144 in place, the respective line lugs 162, 164 of the main breaker 118 can be connected to the replacement line straps 142, 144 at the elevated level. The replacement line straps 142, 144 shown in FIG. 4 prior to installing the main breaker 118, and the elevation of the line connectors 124, 128 of the MID 120 provide for elevation of main breaker 118 above the elevation of the back surface 148 (labeled in FIGS. 5-6) of the MID 120 as shown in FIG. 7. The load connectors 166, 168 of the main breaker 118 are connected mechanically and electrically to the line connectors 124, 128 (labeled in FIG. 4-6) of the MID 120.

With the main breaker 118 in an ON state, the main braker 118 electrically connects the first line 134 of the electrical panel 100 in series with a first line connector 124 (labeled in FIG. 5) of the MID 120 and electrically connects the second line 138 of the electrical panel in series with a second line connector 128 (labeled in FIG. 5) of the MID 120. In the OFF state of the main breaker 118, both lines 134, 138 are electrically disconnected from the MID 120 within the main breaker 118. Similarly, with the MID 120 in an ON state, the MID 120 electrically connects the first line connector 124 (labeled in FIG. 5) of the MID 120 to the first line bus 110 of the interior 106 and connects the second line connector 128 (labeled in FIG. 5) of the MID 120 to the second line bus 114 of the interior 106, and in the OFF state of the MID 120, both lines connectors 124, 128 are electrically disconnected from the respective busses 110, 114 within the switching device 122 of the MID 120, labeled in FIG. 6.

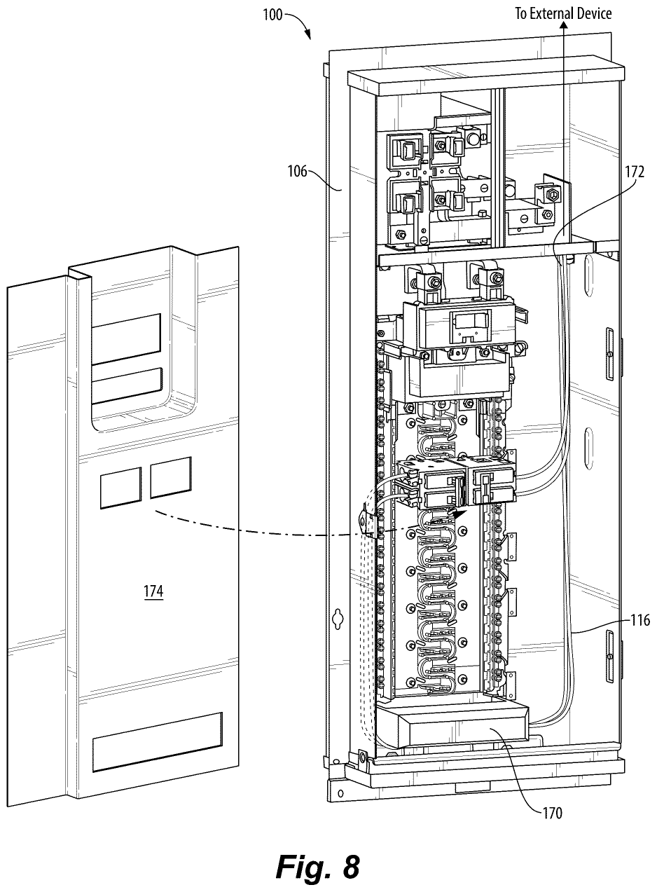

With continued reference to FIG. 7, optionally, the PCBA 150, controller 152, and communication port 158 labeled in FIG. 6 can be included in an MID controller 170 separate from the MID 120. The MID controller 170 can be connected as shown in FIG. 8 by a cable to control the MID 120, and a data line 172 can run from the communication port 158 (labeled in FIG. 6) to an external device for telemetry and/or control of the MID 120. The method can include mounting the MID controller 170 in the electrical panel, e.g., on an end of the interior 106 opposite from the MID 120. After installing the MID 120 and connecting the main breaker 118 as described above, the method includes re-installing the deadfront 102, or e.g., if it no longer fits, installing a new deadfront 174 to the panel housing 104.

Systems and methods as disclosed herein provide potential benefits including the following. They provide for the use of MID's in Square D CSED panels and the like, which can be retrofitted into existing panels or used in new installations. This can provide for control to intermittently run an electrical panel as a microgrid electrically islanded or isolated from the utility grid. No pole spaces are lost since the additional space used up after the retrofit can just fill what was formerly dead space. The envelope of original panel is maintained.

The methods and systems of the present disclosure, as described above and shown in the drawings, provide for new installation or retrofitting legacy electrical panels such as common service entrance device (CSED) panels, indoor/outdoor load centers, or the like, to include a microgrid interconnect device (MID). While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of retrofitting an electrical panel comprising:
removing a main breaker from an interior, wherein the interior is installed in a panel housing of the electrical panel;
removing a first line strap from connecting a first line bus of the interior to a first line of the electrical panel;
removing a second line strap from connecting a second line bus of the interior to a second line of the electrical panel;
installing a microgrid interconnect device (MID) onto the interior in a position formerly occupied by the main breaker; and
connecting the main breaker in electrical series between the first and second lines of the electrical panel and the MID.

2. The method as recited in claim 1, wherein connecting the main breaker includes:
connecting a first replacement line strap to the first line of the electrical panel, wherein the first replacement line strap extends from a first level proximate a back interior surface of the panel housing to an elevated level spaced apart from the back interior surface and from the first level;
connecting a second replacement line strap to the second line of the electrical panel, wherein the second replacement line strap extends from the first level to the elevated level; and
connecting the main breaker to the first line strap and to the second line strap at the elevated level,
wherein with the main breaker in an ON state, the main braker connects the first line of the electrical panel in series with a first line connector of the MID and connects the second line of the electrical panel in series with a second line connector of the MID, and
wherein with the MID in an ON state, the MID connects the first line connector of the MID to the first line bus of the interior and connects the second line connector of the MID to the second line bus of the interior.

3. The method as recited in claim 1, wherein prior to removing the main breaker, there are a plurality of branch devices installed on the interior, electrically connecting the first and second line busses of the interior to individual branch circuits, and further comprising:
keeping the plurality of branch devices installed before, during, and after removing the main breaker, installing the MID, and connecting the main breaker in series between the first and second lines of the electrical panel and the MID.

4. The method as recited in claim 1, further comprising connecting an MID controller to the MID and mounting the MID controller in the electrical panel.

5. The method as recited in claim 4, further comprising connecting an external device a communication port of the MID controller.

6. The method as recited in claim 1, further comprising:
prior to removing the main breaker from the interior, removing a deadfront from the panel housing to provide access to the interior of the electrical panel; and
after installing the MID and connecting the main breaker in series between the first and second lines of the electrical panel and the MID, re-installing the deadfront or installing a new deadfront to the panel housing.

7. A microgrid interconnect device (MID) comprising:
a switching device;
a first line connector electrically connected to the switching device and configured to electrically connect to a first line of an electrical panel;
a second line connector electrically connected to the switching device and configured to electrically connect to a second line of the electrical panel;
a first load connector electrically connected to the switching device and configured to electrically connect to a first line bus of an interior of the electrical panel; and
a second load connector electrically connected to the switching device and configured to electrically connect to a second line bus of the interior;
wherein the switching device is configured to switch between an ON state and an OFF state,
wherein in the ON state, the switching device electrically connects the first line connector to the first load connector and electrically connects the second line connector to the second load connector, and
wherein in the OFF state, the switching device electrically isolates the first line connector from the first load connector and electrically isolates the second line connector from the second load connector.

8. The MID as recited in claim 7, further comprising a housing, wherein the switching device is in an interior space of the housing, wherein each of the first load connector, the second load connector, the first line connector, and the second line connector extends from an exterior space, through the housing, and into the interior space of the housing.

9. The MID as recited in claim 8, wherein the housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction closer to the first elevation than is the second elevation.

10. The MID as recited in claim 9, wherein the housing is configured to fit in an envelope of a QOM2 main breaker.

11. The MID as recited in claim 9, further comprising:
a printed circuit board assembly (PCBA) within the interior space of the housing, wherein the PCBA includes a controller configured to control the switching device to switch the switching device between the ON state and the OFF state;
a first sensor operatively connected to feedback signals indicative of current in the first load connector to the controller for feedback based control of the switching device; and
a second sensor operatively connected to feedback signals indicative of current in the second load connector to the controller for feedback based control of the switching device.

12. The MID as recited in claim 11, further comprising at least one communication port configured for connection to devices outside of the housing, wherein the at least one communication port is operatively connected to the PCBA for data exchange between the PCBA and an external device.

13. An electrical panel comprising:
a panel housing defining a back interior surface and including a first line and a second line;
an interior in the panel housing adjacent the back interior surface;
a main breaker connected mechanically and electrically to the first line and to the second line; and
a microgrid interconnect device (MID) in the panel housing, wherein the MID is connected mechanically to the interior and to the main breaker, wherein the MID is connected in electrical series between the main breaker and the interior.

14. The electrical panel as recited in claim 13, further comprising a plurality of branch devices operatively connected to the interior to control individual circuits respectively connected to the branch devices by respective wires.

15. The electrical panel as recited in claim 13, wherein the MID includes:
a switching device;
a first line connector electrically connected to the switching device and to the first line of the panel housing through the main breaker;
a second line connector electrically connected to the switching device and to the second line of the panel housing through the main breaker;
a first load connector electrically connected to the switching device and to a first line bus of the interior; and
a second load connector electrically connected to the switching device and to a second line bus of the interior;
wherein the switching device is configured to switch between an ON state and an OFF state,
wherein in the ON state, the switching device electrically connects the first line connector to the first load connector and electrically connects the second line connector to the second load connector, and
wherein in the OFF state, the switching device electrically isolates the first line connector from the first load connector and electrically isolates the second line connector from the second load connector.

16. The electrical panel as recited in claim 15, further comprising an MID housing, wherein the switching device is in an interior space of the MID housing, wherein each of the first load connector, the second load connector, the first line connector, and the second line connector extends from an exterior space, through the MID housing, and into the interior space of the MID housing.

17. The electrical panel as recited in claim 16, wherein a neutral line of the panel housing connects directly to a neutral bus of the interior.

18. The electrical panel as recited in claim 16, wherein the MID housing includes a back surface at a first elevation in a z-direction defined perpendicular to the back surface, wherein respective terminals of the first and second line connectors are positioned at a second elevation in the z-direction spaced apart from the first elevation, wherein terminals of the first and second load connectors are positioned at a third elevation in the z-direction closer to the first elevation than is the second elevation.

19. The electrical panel as recited in claim 16, further comprising:
a printed circuit board assembly (PCBA) within the interior space of the MID housing, wherein the PCBA includes a controller configured to control the switching device to switch the switching device between the ON state and the OFF state;
a first sensor operatively connected to feedback signals indicative of current in the first load connector to the controller for feedback based control of the switching device; and
a second sensor operatively connected to feedback signals indicative of current in the second load connector to the controller for feedback based control of the switching device.

20. The electrical panel as recited in claim 19, further comprising at least one communication port configured for connection to devices outside of the MID housing, wherein the at least one communication port is operatively connected to the PCBA for data exchange between the PCBA and an external device.
